(19) United States
(12) Patent Application Publication
(10) Pub. No.: US 2025/0339838 A1
(43) Pub. Date: Nov. 6, 2025

(54) HERBAL ABSORBENT MATERIAL FOR COMBATING OIL AND OIL SPILLS

(71) Applicant: ISTANBUL TEKNIK UNIVERSITESI, Istanbul (TR)

(72) Inventors: Ismail KOYUNCU, Istanbul (TR); Omer KARA, Istanbul (TR); Bahar YAVUZTURK GUL, Istanbul (TR); Mehmet Emin PASAOGLU, Istanbul (TR); Sevde KORKUT, Istanbul (TR)

(73) Assignee: ISTANBUL TEKNIK UNIVERSITESI, Istanbul (TR)

(21) Appl. No.: 18/860,737

(22) PCT Filed: Mar. 21, 2023
(86) PCT No.: PCT/TR2023/050267

§ 371 Date: Oct. 28, 2024

(30) Foreign Application Priority Data
Apr. 28, 2022 (TR) 2022/007076

(51) Int. Cl. B01J 20/24; B01J 20/28; C02F 1/28; C02F 101/32; C09K 3/32

(52) U.S. Cl. CPC B01J 20/24; B01J 20/28033; C02F 1/286; C09K 3/32; C02F 2101/32

(57) ABSTRACT

A use of pre-treated Verbascum (mullein) as an absorbent material to ensure that products such as oil and petroleum mixed with water are separated and cleaned from the water, is provided. The pre-treated Verbascum also can be used in packages by placing it in a porous structure carrier material, where the porous structure carrier material is an absorbent pad, an absorbent cushion, or a permeable material with a porous structure.

### CROSS REFERENCE TO THE RELATED APPLICATIONS

This application is the national phase entry of International Application No. PCT/TR2023/050267, filed on Mar. 21, 2023, which is based upon and claims priority to Turkish Patent Application No. 2022/007076, filed on Apr. 28, 2022, the entire contents of which are incorporated herein by reference.

### TECHNICAL FIELD

The invention relates to the use of pre-treated Verbascum (mullein) as an absorbent material to remove products such as oil and petroleum mixed with water.

### BACKGROUND

In marine accidents, fuel oil spills, ports, inland waters, petroleum platforms (wherever petroleum derivatives are used) cause oil, petroleum and derivatives pollution and need to be cleaned. In the known state of the art, there are various methods used against the aforementioned spills. One of these methods is petroleum barriers. The barriers, called petroleum booms, provide cleanup by trapping the petroleum. They have three main components: a freeboard to trap the petrol rising above the water surface, a part called a skirt placed under the freeboard below the surface, and a chain connecting the parts. However, it is disadvantageous because of its limited range of applications and its suitability for cleaning up oil spills in a single area. However, the effectiveness of the method decreases as the amount of petrol spilled increases. Petrol booms are also not suitable for areas with strong waves, windy conditions and strong tides.

One of the methods used in the technical field is sorbents. Two types of sorbents are used for oil and petroleum cleaning. These are sorbents that absorb oil and adsorbents that do not absorb oil but instead form a layer on the surface. Materials such as silk grass fiber, Populus seed fiber, peat moss and corn cobs are commonly used as oil sorbents to prevent marine pollution. These petrol-absorbing materials are produced in the form of pillows, sausages and pads and are placed on the polluted seawater causing pollution to absorb the petrol.

Their advantage is that they are organic and cheap. The disadvantage is that they only absorb 3 to 15 times their weight. In addition, they have several disadvantages, such as being difficult to retrieve. In the worst case scenario, absorbents can sink under their own weight and pose a risk to aquatic life.

Skimmers are another alternative used for the same purpose. Mounted on the side of boats, skimmers are specially designed to collect water from the water surface. They are able to separate water and oil, making the oil reusable. However, they do not offer a long-lasting solution due to the presence of debris, clogging problems and thus becoming unusable.

Another alternative is high pressure washing. This method serves the purpose of washing rather than cleaning the water. Water heated to 170° C. is then sprayed through high-pressure nozzles into areas with trapped oil. The pressure flushes the oil to the water surface where it can be collected by skimmers or booms. This procedure is mainly applied where the petrol cannot be accessed by larger machinery, such as on the beach. It is not the best option for the seas as high pressure can disperse the petrol, contaminate clean water with petrol and endanger marine life.

In-situ burning is a method used to separate and destroy petrol. The oil floating on the surface is ignited to burn it, so the procedure is simple, but the burning process is subject to strict supervision. In-situ burning is much more effective than other petrol spill cleanup methods. It can remove up to 98% of the oil. However, it cannot be used in every accident and the thickness of the spill must be at least 3 mm on the surface to be incinerated. Thinner layers are more difficult, sometimes even impossible, to remove. Adverse weather conditions are also not compatible with in-situ burning. In addition, it is not an eco-friendly method.

Gelatinization is the process of applying a powdery substance to petrol spills on water, used for the same purpose. The compound traps the oil and forms a more solid gelatin. This makes it possible to separate the oil from the water. The oil-gelatin compound is then collected by nets and skimmers. Although this method is effective, it is difficult to implement. The ratio of oil and gelatin is 1:3, so three times the amount of gelatin is needed to extract the oil. For some accidents it is not possible to achieve this ratio.

The bioremediation method is based on the use of specific microorganisms such as bacteria, algae and fungi. Their aim is to break down the oil into simpler and non-toxic molecules. For the method to be as effective as possible, the fungi or algae must be as large as possible. To facilitate the growth of the above, reagents and fertilizers can be added to the contaminated water. This leads to extra economic costs.

In the known state of the art, the patent application document numbered KR100819461 relates to oil absorbent nets containing kapok fibers. In the said document, an oil absorbent net structure containing kapok fiber, which is easy to produce and reusable, is mentioned for easy and simple cleaning of petrol spilled into the sea or rivers. It is stated that the kapok fiber is filled into a porous carrier that is insoluble in water or oil. It is also explained in the document that after oil absorption, the net is recovered by using a machine such as a press and that the oil absorbent nets can effectively clean the floating oil or organic solvent in the sea or rivers in case of oil or organic oil outflow in the sea or river.

United States patent application US2014217004 relates to a sorption pad for sorbing oil or fat products. The document states that the absorption pad consists of a sorbent material enclosed in a porous structure, and that the sorbent material may be any hydrophobic sorbent material, including natural or synthetic solids, fibers, granules and powders, and that the type is determined by manufacturer preference and may depend on local availability, cost and performance.

### SUMMARY

The main object of the invention is to develop a herbal sorbent material to combat petroleum and oil spills and to ensure cleanliness. The inventive product is a herbal sorbent or treatment material that separates all mineral and vegetable floating liquid substances such as petroleum and hydrocarbons from marine, water and wastewater environments. It can be packaged in any porous form (such as pads, pillows, etc.) suitable for any industry.

The object of the invention is to use the pre-treated Verbascum plant as an absorbent in marine accidents, fuel oil spills, ports, inland waters, petroleum platforms, in short, wherever petroleum derivatives are used. It can be used with any porous material for the separation of petroleum derivatives such as mineral oil, gasoline, diesel, etc. mixed with water.

The aspects of the inventive product that distinguish it from the known state of the art are summarized below.
Mullein, which has many endemic species in Türkiye, was pre-treated and used for petroleum and oil cleaning. The oil retention capacity of the plant pretreated before use was increased. The genus Verbascum, also known as mullein in Anatolia, is one of the largest genera of the Scrophulariaceae family. The genus, which is represented by more than 360 species in the world, grows widely in the temperate regions of the Northern Hemisphere, especially in the eastern part of Eurasia. In Türkiye, a total of 245 species are distributed under 13 groups, 80% of which are endemic and 130 of which are hybrids [1]. The general distribution area of Verbascum species is Anatolia [2]. Phytochemical studies on Verbascum species have obtained glycosides, flavonoids, polysaccharides, saponins, steroids and alkaloids [3]
The plant is easily available from local sources and can be used after simple pre-treatment.
Can be used in any permeable sheath.
The new developed product can be installed on boats on a large scale and can be used in all kinds of windy and wavy conditions.
One of the most important features of the product is that the petroleum, fuel oil and oils it absorbs are recovered at a high rate after the squeezing/pressing process is applied.
As an absorbent sorbent, the material is suitable for repeated use until the absorption capacity is full.
When the absorption capacity is full, it can be recycled as it is vegetable-based.
The suction efficiencies given in the laboratory scale are measurements taken within 5 minutes.

The object of the invention is to obtain a biotechnological product that is domestic, cheap, suitable for use in different conditions, can be used repeatedly, can be used again and again, and can recycle the petroleum and oil it adsorbs by using the pre-treated Verbascum plant in oil and petroleum cleaning. In this way, it will be possible to eliminate foreign dependency in this field.

### BRIEF DESCRIPTION OF THE DRAWINGS

The “HERBAL ABSORBENT MATERIAL FOR USE IN COMBATING PETROLEUM AND OIL SPILLS”, which is realized to achieve the object of the present invention, is described only for a better understanding of the subject matter and without limiting effect.

FIG. 1 is graph of adsorption efficiencies obtained.

FIG. 2 is FTIR spectrum of adsorption applied in bilge wastewater.

FIG. 3 is FTIR spectrum of adsorption applied on lube oil sample.

FIG. 4 is FTIR spectrum of adsorption applied on diesel sample.

FIG. 5 is FTIR spectrum of adsorption applied on gasoline sample.

FIG. 6 is efficiency comparison graph of Verbascum plant with and without pretreatment.

### DETAILED DESCRIPTION OF THE EMBODIMENTS

The invention relates to the use of Verbascum (mullein) as an absorbent material for cleaning products such as oil and petroleum mixed with water by separating them from the water in a short time. In a preferred embodiment of the invention, the said absorbent material can be used in packages by placing it in a porous carrier material.

Verbascum is a biennial herbaceous plant, 20 to 150 cm tall, with bright yellow flowers in June-August and can grow spontaneously in uncultivated areas and roadsides. In pharmacological studies, antihistamine, antifungal, antibacterial and antioxidant effects of some Verbascum species have been determined. Flowers contain mucilage, essential oil and glycosides. It is known to be used as an expectorant and chest softener. The seeds of some cattail species are poisonous to fish because they carry saponins and are used for fishing. Türkiye is very rich in cattail species and there are approximately 200 species.

In the studies conducted within the scope of the invention, the oil and petroleum adsorption capacity of the plant was measured. In order to be used against lube oil, where it showed the highest adsorption potential, the plant was pre-treated and its adsorption capacity was increased. The samples used are gasoline, diesel, lube oil and bilge water.

In order to determine the oil and petroleum adsorption capacity of the plant, it was observed how much of the oil/petroleum mixture to be cleaned was absorbed by reusing the packages prepared with the plant repeatedly in the measurements. Some of the terms used are explained below.

Total absorbed sample: The total amount of sample absorbed as a result of reusing the same plant package repeatedly.

Total absorbed sample efficiency: 1−((initial amount-adsorbed amount)/initial amount)×100

6 g of mullein plants were weighed with a precision balance and placed in the carrier porous material and packed. Then the total weight was weighed. The sample was mixed with seawater at a ratio of 5:1. The mixture was transferred to the test container. The packaged plant was immersed in the container containing the samples and the amount of sample adsorbed was measured with a tape measure and the efficiency was calculated. The phase difference between the seawater and the sample was used in the measurement. The results of the experiments performed using the package method are as follows:

### In Case Lube Oil is Used as a Sample,

1000 ml of sea water and 200 ml of lube oil sample were mixed and put into the test container. Packages prepared with 6 g of plant were dipped into the mixture repeatedly and the plant was enabled to absorb the mixture. The packages were then squeezed into a clean beaker and the oil was collected, measured with a tape measure and the efficiency was calculated.

$$Total mixture absorbed by plant packages = 230 ml$$

$$Total seawater absorbed by plant packages = 62 ml$$

$$Total lube oil absorbed by plant packages = 168 ml$$

$$Efficiency = ( 1 - ( 200 - 168 ) / 200 ) \times 100 = 84 \%$$

### In Case Bilge is Used as a Sample,

The seawater-bilge sample prepared as 5:1 is dipped more than once with the packages prepared with 6 g of the plant and the plant is enabled to absorb the mixture. Then, the packages were squeezed into a clean beaker, the sample was collected, measured with a tape measure and the efficiency was calculated.

$$Total mixture absorbed by plant packages = 51 ml$$

$$Total seawater absorbed by plant packages = 22 ml$$

$$Total bilge absorbed by plant packages = 29 ml$$

$$Efficiency = ( 1 - ( 50 - 29 ) / 50 ) \times 100 = 58 \%$$

### In Case Gasoline is Used as a Sample,

The seawater-gasoline sample prepared as 5:1 was dipped more than once with the packages prepared with 6 g of the plant and the plant was enabled to absorb the mixture. Then, the packages were squeezed into a clean beaker, the sample was collected, measured with a tape measure and the efficiency was calculated.

$$Total mixture absorbed by plant packages = 50 ml$$

$$Total seawater absorbed by plant packages = 31.5 ml$$

$$Total gasoline absorbed by plant packages = 18.5 ml$$

$$Efficiency = ( 1 - ( 50 - 18.5 ) / 50 ) \times 100 = 37 \%$$

### In Case Diesel is Used as a Sample.

The seawater-diesel sample prepared as 5:1 is dipped more than once with the packages prepared with 6 g of the plant and the plant is enabled to absorb the mixture. Then, the packets were squeezed into a clean beaker, the sample was collected, measured with a tape measure and the efficiency was calculated.

$$Mixture quantity = 300 ml ( 50 ml diesel )$$

$$Total diesel absorbed by plant packages = 30 ml$$

$$Efficiency = ( 1 - ( 50 - 30 ) / 50 ) \times 100 = 60 \%$$

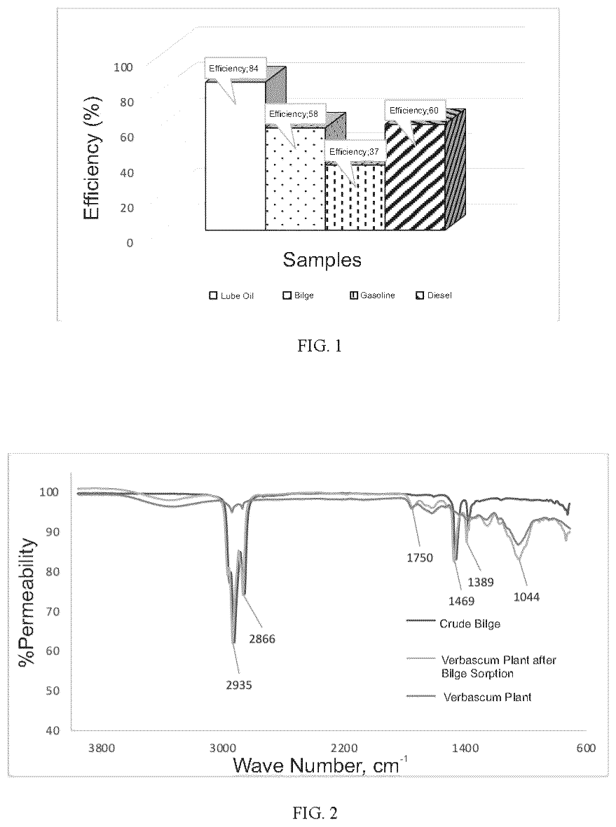

All efficiencies rates obtained are given in Table 1 and FIG. 1.

TABLE 1
Adsorption efficiencies obtained with Verbascum plant

| Sample | Efficiency (%) |
|---|---|
| Lube oil | 84 |
| Bilge | 58 |
| Gasoline | 37 |
| Diesel | 60 |

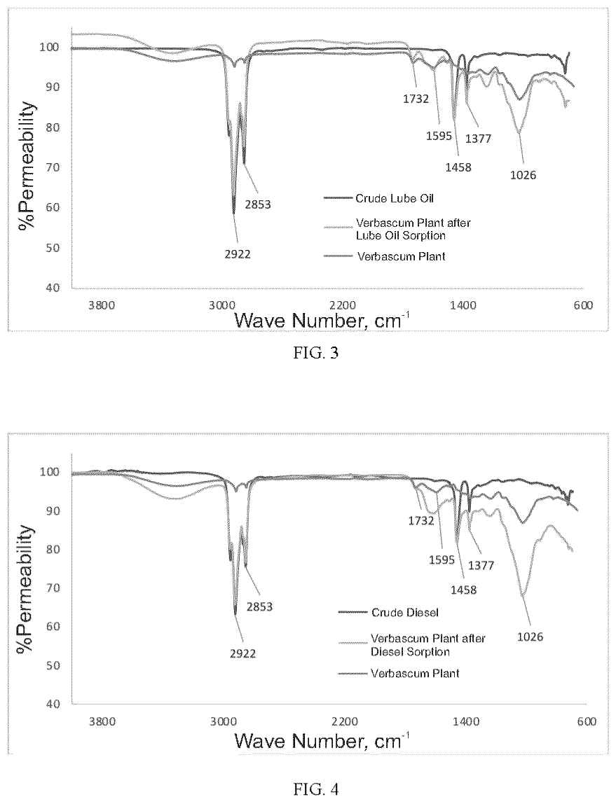

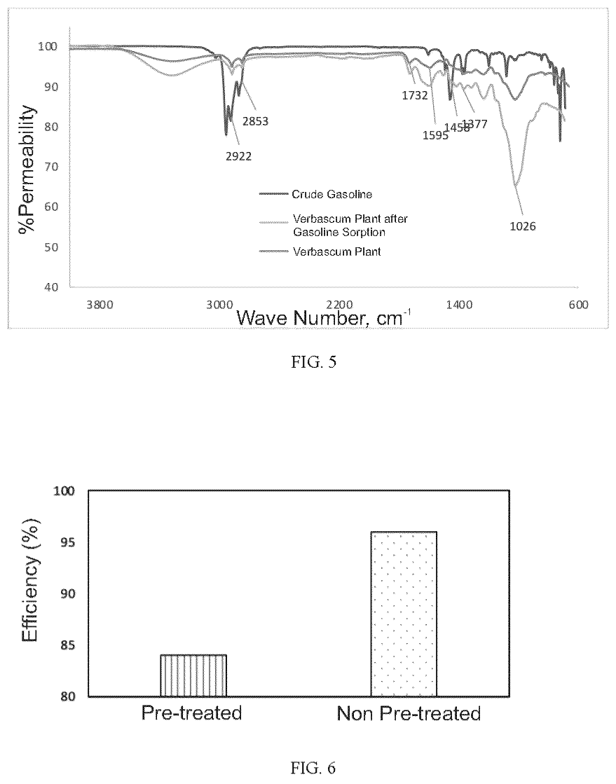

As a result of the adsorption experiments applied to the samples, TOC analysis was performed on the adsorbed samples and FTIR measurements were performed on the plant parts obtained from the packages. Table 2 and FTIR spectra graphs (FIGS. 2-5) of these measurements are given below.

TABLE 2
Total organic carbon concentrations as a result of adsorption

| | Initial | Post adsorption | |
|---|---|---|---|
| | concentration | concentration | Efficiency |
| Sample | (mg/L) | (mg/L) | (%) |
| Lube oil | 1516 | 1347 | 11 |
| Bilge | 4593 | 1309 | 72 |
| Gasoline | 4341 | 3260 | 25 |
| Diesel | 1680 | 1386 | 15 |

It is understood that Verbascum plant shows prominent absorption bands at 3280, 2919, 2853, 1734, 1638, 1417, 1369, 1026 and 515 cm-1 when FTIR spectrum analyzed. The strong band at 3280 cm-1 may result from the —OH stretching vibration attributed to glycosides. The bands at 2922 cm-1, 2853 cm-1 may result from C—H stretching vibrations, while 1417 and 1369 cm-1 may be assigned to —C—O stretching or —O—H deformation vibration. The weak band at 1734 cm-1 can be linked to the carbonyl functional group in esters. Reduction of the band further to 1638 cm-1, possibly as a result of conjugation of the carbonyl with a double bond or aromatic ring, or chelation to a nearby-OH.

The results obtained without any pretreatment of the plant are summarized above. The lube oil with the highest performance of the plant was selected for further trials. As a result of the studies performed within the scope of the invention, for the first time in the technical field, Verbascum plant was pre-treated to maximize oil adsorption. For this purpose, the following procedure was applied:

The plant sample was soaked in NaOH (1N) for 24 hours. Then it was left to dry for 72 hours. The dried plant sample was tested in a seawater-lube oil mixture at the rate of 5:1.

$$Adsorbed Lube oil = 48 ml$$

$$Efficiency = ( 1 - ( 50 - 48 ) / 50 ) \times 100 = 96 \%$$

The oil adsorption capacity of the pretreated plant sample increased from 84% to 96%. FIG. 6 shows the efficiency comparison graph of the pretreated and non-pretreated plant.

In conclusion, the adsorption capacity of Verbascum plant was first determined and the capacity of the plant was significantly increased with the pretreatment applied. This pretreatment has not been tried with Verbascum plant before. According to the FTIR spectrum, the bands at 2922, 2853, 1458, 1377/1369 cm-1 show overlap in the plant and sample spectrum after adsorption in all samples. The overlap of organic structures belonging to these peaks proves that the plant retains these materials on its surface. The maximum adsorption capacity of Verbascum plant was found to be 84%. The best efficiency was obtained in the Lube oil sample. After pretreatment, the efficiency reached 96% in this sample.

In order to determine the Specific Adsorption Capacity (SAC) of the plant, a large scale adsorption experiment was conducted against a commercial competitor product. In summary, in the experiment, the adsorbent material used as reference and Verbascum plant were dipped in lube oil with equal weight of 2.85 kg in a 3000 mm length and 150 mm diameter in a porous sheath. instantaneous and long-term (30 minutes and 24 hours) adsorption tests were performed. For this process, on the first day, the weight of the samples was weighed for the oil absorbed after the samples were removed from the oil for 30 minutes. The containers used for weight measurements of the oil samples were tared. Empty weight of container No. 1 was weighed as 12.05 kg and empty weight of container No. 2 was weighed as 13 kg. In the measurements of the samples, it was understood that the weight of the product in the container No. 1 was as 35.85 kg and that it absorbed a total of 23.80 kg of oil. The reference product in container 2 weighed 35.30 kg and absorbed 22.30 kg of oil.

On the second day, the same samples were exposed to machine oil for 24 hours to measure the long-term absorption performance of the samples after the measurements and observations made on the first day. At the end of 24 hours, the weight of the product in container No. 1 was 36 kg and it was found that it absorbed a total of 23.95 kg of oil. The weight of the reference product in container No. 2 was 37.25 kg and absorbed a total of 24.25 kg of oil. Sample dimensions are 15 cm in diameter and 3 m in length. Both samples are of equal weight and dimensions. The results Table 3 shows the specific adsorption capacity calculated based on the 30-minute test results.

Specific Adsorption Capacity (SAC): It determines how many times its own weight of material the plant package can adsorb in a trial.

$$SAC = ( Adsorption test result - Plant weight ) / Plant weight )$$

TABLE 3
Large-scale determination of the specific
absorption capacity of Verbascum

| | Total adsorbed | Specific Adsorption |
|---|---|---|
| | sample (kg) | Capacity (30 min) |
| Verbascum | 23.80 | 11.6 |
| Reference Product | 22.30 | 11.4 |

Table 4 below shows the specific adsorption capacity of kapok fiber, another plant source used as absorbent in the literature, as revealed in different studies. Although there are different results in different studies, the SAC changes between 11-54.

TABLE 4
Specific adsorption capacity of Kapok
fiber determined in different studies

| | Specific adsorption | |
|---|---|---|
| Adsorbent material | capacity, g/g diesel | Source |
| Crude kapok fiber | 38.1 | Wang et al., 2012 [4] |
| (0.1 g) | | |
| Pre-treated kapok | 54.2 | Wang et al., 2012 [4] |
| fiber (0.1 g) | | |
| Pre-treated kapok | 11.8 | Rengasamy et al., 2011 [5] |
| fiber | | |
| Crude kapok fiber | 19.35 | Ali et al., 2012 [6] |

In the light of the findings obtained, it is revealed that the pretreated Verbascum plant, which is used for oil-petroleum cleaning for the first time in the relevant technical field and in the literature, has a very high capacity to remove oil and petroleum derivatives from seawater. It is also convenient for repeated use with appropriate technical devices. Since it is a highly effective biotechnological method, studies in this direction have great importance.

### REFERENCES

[1]. Küçük, S. (2017). ANATOMICAL CHARACTERISTICS OF ENDEMIC VERBASCUM BELLUM HUB. AND MOR. (SCROPHULARIACEAE). Anadolu University Journal of Science and Technology C-Life Sciences and Biotechnology, 6 (1), 22-30. DOI: 10.18036/aubtdc.291669
[2]. Alan, S. & Gökman, A. B. (2015). Endemik Verbascum orgyale Boiss. & Heldr. türünün morfolojik, morfometrik ve anatomik özelliklerinin incelenmesi. Biyolojik çeşitlilik ve Koruma, 8 (1), 94-103. Retrieved from https://dergipark.org.tr/tr/pub/biodicon/issue/55740/762405
[3]. Turker, A. U., Camper, N. D. 2002. Biological Activity of Common Mullein, A Medicinal Plant, J. of Ethnopharmacology 82, 117-125.
[4]. Wang, J., Zheng, Y., & Wang, A. (2012). Superhydrophobic kapok fiber oil-absorbent: Preparation and high oil absorbency. Chemical Engineering Journal, 213, 1-7.
[5]. Rengasamy, R. S., Das, D., & Karan, C. P. (2011). Study of oil sorption behavior of filled and structured fiber assemblies made from polypropylene, kapok and milkweed fibers. Journal of Hazardous Materials, 186(1), 526-532.
[6]. Ali, N., El-Harbawi, M., Jabal, A. A., & Yin, C. Y. (2012). Characteristics and oil sorption effectiveness of kapok fibre, sugarcane bagasse and rice husks: oil removal suitability matrix. Environmental technology, 33(4), 481-486.

What is claimed is:

1. A method for separating and cleaning a product mixed with water from the water, comprising using pre-treated Verbascum (mullein) as an absorbent material, wherein the product comprises oil and petroleum.

2. The method according to claim 1, wherein the pre-treated Verbascum is further used in packages by placing the pre-treated Verbascum in a porous structure carrier material.

3. The method according to claim 2, wherein the porous structure carrier material is an absorbent pad.

4. The method according to claim 2, wherein the porous structure carrier material is an absorbent cushion.

5. The method according to claim 2, wherein the porous structure carrier material is a permeable material with a porous structure.
